(19) United States
(12) Patent Application Publication
(10) Pub. No.: US 2014/0107272 A1
(43) Pub. Date: Apr. 17, 2014

(54) ONE-TIME APPLICABLE TWO-COMPONENT COATING COMPOSITION FOR CHROME-PLATED SURFACE

(71) Applicant: JUYOUNG INDUSTRIAL CO., LTD, Yangsan-si (KR)

(72) Inventors: Ho-jin SUNG, Yangsan-si (KR); Hang-yong CHOI, Busan (KR); Jong-gun KANG, Yangsan-si (KR)

(73) Assignee: JUYOUNG INDUSTRIAL CO., LTD, Yangsan-si (KR)

(21) Appl. No.: 13/859,121

(22) Filed: Apr. 9, 2013

(30) Foreign Application Priority Data
Oct. 16, 2012 (KR) 10-2012-0114950

(51) Int. Cl. C09D 5/00

(52) U.S. Cl. CPC C09D 5/002
USPC 524/425; 524/447; 524/451

(57) ABSTRACT

The present invention relates to a one-time applicable two-component coating composition for a chrome-plated surface and, more particularly, to a one-time applicable two-component coating composition which can be applied to a chrome-plated surface once because it is used instead of a commercially available two-time applicable coating composition including a primer coating material and a finish coating material and which can satisfy the adhesiveness, chipping resistance and other physical properties necessary for automobile exterior painting materials.

### REFERENCE TO RELATED APPLICATIONS

This application claims the priority benefit of Korean Patent Application No. 10-2012-0114950 filed on Oct. 16, 2012, the entire contents of which are incorporated herein by reference.

### FIELD OF THE INVENTION

The present invention relates to a one-time applicable two-component coating composition for a chrome-plated surface and, more particularly, to a one-time applicable two-component coating composition which can be applied to a chrome-plated surface once because it is used instead of a commercially available two-time applicable coating composition including a primer coating material and a finish coating material and which can satisfy the adhesiveness, chipping resistance and other physical properties necessary for automobile exterior painting materials.

### BACKGROUND OF THE INVENTION

Currently, in the field of automobile parts, exterior parts, such as radiator grills, door knobs, garnish emblems, and interior parts, such as handles, center fascias and gear boxes are plated with chrome.

Particularly, a radiator grill for an automobile is plated with hexavalent chrome and trivalent chrome in order to impart a beautiful appearance to the radiator grill. In this case, when the radiator grill is plated with hexavalent chrome, a white mirror image is realized, and when the radiator grill is plated with trivalent chrome, a luxurious dark mirror image is realized.

Hexavalent chrome (Cr) has been slowly replaced by trivalent chrome (Cr) because it belongs to a group of six cancer-causing materials (lead, mercury, cadmium, hexavalent chrome, PBBS (polybrominated bisphenols), PBDES (polybrominated diphenyl ethers)) regulated by RoHS (Restriction of Hazardous substances).

Currently, a general method of manufacturing a chrome-plated radiator grill includes the steps of: injection-molding an ABS resin in a designed shape to form a radiator grill product; washing the surface of the radiator grill product and then sequentially plating the surface thereof with copper, nickel and chrome; applying a primer coating material to the plated surface of the radiator grill product; and applying a finish coating material (base coating material) to the primer coating material. That is, in this method, coating processes are carried out two times using a primer coating material and a finish coating material.

A coating material applied on the trivalent or hexavalent chrome-plated surface of the radiator grill is harmonized with the non-coated chrome-plated surface thereof to improve the appearance of the radiator grill more gracefully. In this case, the coating material applied on the chrome-plated surface thereof must have sufficient adhesiveness to the chrome-plated surface thereof, and, particularly, must have chipping resistance for minimizing the damage caused by external impact. Here, the term “chipping” means a phenomenon that a coating layer is detached by external impact caused by a stone or the like.

In a conventional two-time applicable coating composition (a primer coating material+a finish coating material), the primer coating material serves to improve chipping resistance by providing adhesiveness to a chrome-plated surface, and the finish coating material needs water resistance, acid resistance alkali resistance, chemical resistance, weather resistance and excellent mechanical, physical and chemical properties.

A large number of conventional coating materials for automobile radiator grills have been proposed.

Korean Unexamined Patent Application Publication No. 10-2010-0042523 discloses a black coating material including a polyester resin, as a primer coating material. Korean Unexamined Patent Application Publication No. 10-2010-0043365 discloses a black coating material for automobile radiator grills, including acrylic polyol, polyester, and modified polyester, as a finish coating material, but this coating material needs a primer coating material.

Meanwhile, Korean Unexamined Patent Application Publication No. 10-2006-0000708 discloses a chipping-resistant black coating composition for automobile radiator grills, which includes a primer coating material containing a chlorinated polyolefin and a silane adhesion improver, and a finish coating material containing polyester polyol, modified polyester polyol and acrylic polyol. However, all of the above-mentioned coating materials include a primer coating material and a finish coating material, which are sequentially applied two times.

Therefore, it is required to research and develop a new kind of coating material which can maintain adhesiveness and chipping resistance even when it is applied to the chrome-plated surface of a radiator grill only one time.

### SUMMARY OF THE INVENTION

Accordingly, the present invention has been devised to solve the above-mentioned problems, and an object of the present invention is to provide a one-time applicable two-component coating composition which can maintain adhesiveness and chipping resistance even when it is applied to the chrome-plated surface of a radiator grill only one time, although a conventional two-time applicable coating composition including a primer coating material and a finish coating material are sequentially applied two times.

The object of the present invention is not limited to the above-mentioned object, and other objects, which are not mentioned, will be clearly understood from the following descriptions.

In order to accomplish the above object, an aspect of the present invention provides a one-time applicable two-component coating composition, which is applied to a chrome-plated surface one time to impart adhesiveness and chipping resistance, comprising: 100 parts by weight of a main material which includes 30˜70 parts by weight of at least one polyol resin selected from among a polyester polyol resin, an acrylic modified polyester polyol resin and an acrylic polyol resin, the polyol resin containing 40˜70% of solid and 0.5˜5% of a hydroxy group and having a number average molecular weight of 1,000˜20,000, 1˜20 parts by weight of a coloring pigment, 5˜30 parts by weight of an extender pigment, 0.1˜5 parts by weight of a thickener, 0.1˜1 parts by weight of a wetting and dispersing agent, 0.1˜1 parts by weight of a defoamer, 1˜5 parts by weight of an adhesion improver, 0.05˜0.5 parts by weight of a leveling agent, 0.01˜0.1 parts by weight of a reaction accelerator, 0.1˜1 parts by weight of an ultraviolet absorber, 0.1˜1 parts by weight of an ultraviolet stabilizer and 20˜40 parts by weight of a mixed solvent; and 10˜30 parts by weight of a curing agent which includes 5˜20 parts by weight of a resin for a curing agent and 5˜15 parts by weight of a solvent for a curing agent.

### DETAILED DESCRIPTION OF THE INVENTION

Hereinafter, preferred embodiments of the present invention will be described in detail with reference to the attached drawings.

The present invention provides a two-component coating composition including a main material and a curing agent. The main material includes a polyol resin, various additives and a solvent, and the curing agent includes a resin for a curing agent and a solvent for a curing agent.

First, the polyol resin of the main material of the two-component coating composition of the present invention, which is applied on a chrome-plated surface, includes at least one of a polyester polyol resin, an acrylic modified polyester polyol resin and an acrylic polyol resin, and has a solid content of 40˜70%, a hydroxy group content of 0.5˜5% and a number average molecular weight of 1,000˜20,000.

In the present invention, the polyol resin includes at least one of a polyester polyol resin, an acrylic modified polyester polyol resin and an acrylic polyol resin, and is used in an amount of 30˜70 parts by weight based on 100 parts by weight of the main material. The three kinds of polyol resins may be used each independently or in the form of a mixture of two or more according to required physical properties. Each of the three kinds of polyol resins has a solid content of 40˜70%, a hydroxy group content of 0.5˜5% and a number average molecular weight of 1,000˜20,000.

It is preferred that the solid content of the polyol resin be 40˜70%. When the solid content thereof is less than 40%, it is difficult to adjust the viscosity of the polyol resin suitable for dispersing the coating composition, and when the solid content thereof is more than 70%, the viscosity of the polyol resin is excessively high, so there is a difficulty in producing the polyol resin.

It is preferred that the hydroxy group content of the polyol resin be 0.5˜5%. When the hydroxy group content thereof is less than 0.5%, crosslink density is low, so a coating film is weak. Further, when the hydroxy group content thereof is more than 5%, crosslink density is excessively high, and thus a coating film is hard, so the coating film has poor flexibility and chipping resistance. Therefore, it is preferred that the hydroxy group content of the polyol resin be 0.5˜5%.

The polyol resin has a number average molecular weight of 1,000˜20,000. When the number average molecular weight of the polyol resin is less than 1,000, a coating film is weak, so the coating film is easily damaged by external impact. Further, when the number average molecular weight thereof is more than 20,000, the storage stability of the polymer resin is deteriorated, and the work for applying the coating composition including the polyol resin is difficult even though the adhesiveness of the polyol resin to chrome is increased according to the elongation of chains of the polyol resin due to the increase of a molecular weight.

In the polyol resin of the present invention, the polyester polyol resin includes 10˜60 parts by weight of a carboxylic acid and a derivative thereof, 10˜50 parts by weight of a glycol of 2˜10 carbon atoms having 2˜4 hydroxy groups, 0.001˜1 parts by weight of a tin-based catalyst for controlling a reaction rate, and 20˜60 parts by weight of a solvent for improving workability, based on 100 parts by weight of the polyol resin.

The polyester polyol resin is synthesized by the polycondensation reaction of an aromatic, cycloaliphatic or aliphatic polyhydric acid and a derivative thereof with a glycol having 2˜4 hydroxy groups. Particularly, considering weather resistance, a cycloaliphatic or aliphatic polyhydric acid and a derivative thereof may be preferably used instead of an aromatic acid and a derivative thereof.

In the polyester polyol resin, when the amount of an aromatic carboxylic acid and a derivative in 10˜60 parts by weight of the carboxylic acid and the derivative thereof is more than 30 parts by weight, weather resistance is low. Further, when the amount thereof is less than 10 parts by weight, hardness is low, thus influencing adhesion. Therefore, the amount of the aromatic carboxylic acid and the derivative may be suitably adjusted in the range of 10˜30 parts by weight.

In the polyester polyol resin, when the amount of a glycol having 3˜4 hydroxy groups in 10˜50 parts by weight of the glycol of 2˜10 carbon atoms having 2˜4 hydroxy groups is less than 10 parts by weight, the polymer chain of the polyester polyol resin has a linear structure, so a coating film can be easily damaged by external impact because it is very weak. Further, when the amount thereof is more than 30 parts by weight, the polymer chain of the polyester polyol resin has a reticular structure, the polyester polyol resin may be gelled during a reaction. Therefore, the amount of the glycol having 3˜4 hydroxy groups may be suitably adjusted in the range of 10˜30 parts by weight.

The tin-based catalyst used to synthesize the polyester polyol resin is an organic tin compound such as DTBO (dibutyl tin oxide), HMBTO (hydrated monobutyl tin oxide) or the like, and serves to control side reactions and shorten reaction time by increasing an ester reaction rate. When the amount of the tin-base catalyst is less than 0.001 parts by weight, the tin-based catalyst cannot sufficiently perform its role as a catalyst. Further, when the amount thereof is more than 1 part by weight, the tin-based catalyst is excessively used, thus resulting in an increase in a product price.

The solvent used to synthesize the polyester polyol resin may be an aliphatic, cycloaliphatic or aromatic solvent of 2˜10 carbon atoms.

Next, in the polyol resin of the present invention, the acrylic modified polyester polyol resin includes 3˜30 parts by weight of a carboxylic acid and a derivative thereof, 2˜30 parts by weight of a glycol of 2˜10 carbon atoms, 5˜50 parts by weight of a vinyl monomer, 0.5˜5 parts by weight of a polymerization initiator, 0.001˜1 parts by weight of a tin-based catalyst for controlling a reaction rate, and 20˜60 parts by weight of a solvent for improving workability, based on 100 parts by weight of the polyol resin.

The acrylic modified polyester polyol resin is divided into an acrylic part and a polyester part, and is prepared by modifying a base polyester resin with an acrylic monomer.

The acrylic modified polyester polyol resin is prepared in a similar method to that of the polyester polyol resin. The acrylic modified polyester polyol resin must include 1˜10 parts by weight of a carboxylic acid having a double bond and a derivative thereof in 3˜30 parts by weight of the carboxylic acid and the derivative thereof and must include 20 parts or less by weight of a glycol having 3˜4 hydroxy groups in 2˜30 parts by weight of the glycol of 2˜10 carbon atoms having 2˜4 hydroxy groups.

When the amount of the carboxylic acid having a double bond and the derivative thereof in 3˜30 parts by weight of the carboxylic acid and the derivative thereof is less than 1 part by weight, an appearance becomes opaque in the process of acrylic modification. Further, when the amount thereof is more than 10 parts by weight, gelation may occur during an acrylic modification reaction. Therefore, the amount of the carboxylic acid having a double bond and the derivative thereof may be suitably adjusted in the range of 1˜10 parts by weight.

When the amount of the glycol having 3˜4 hydroxy groups is more than 20 parts by weight, a polymer chain has a reticular structure, and thus gellation may occur during an acrylic modification reaction. Therefore, the amount of the glycol having 3˜4 hydroxy groups may be suitably adjusted in the range of 20 parts or less by weight.

The polyester resin prepared in this way has low crosslink density and a linear molecular structure compared to the polyester polyol resin. When the amount of polyester in the acrylic modified polyester polyol resin is more than 50 parts by weight, a coating film is weak, so the coating film is easily damaged by external impact. Further, when the amount thereof is less than 5 parts by weight, a coating film becomes brittle, and thus the chipping resistance of the coating film becomes poor. Therefore, the amount of polyester in the resin may be suitably adjusted in the range of 5˜50 parts by weight.

The vinyl monomer may include at least one selected from among acrylic acid, methacrylic acid, acrylic acid alkyl ester, methacrylic acid alkyl ester, a hydroxy-containing vinyl monomer and a styrene monomer. When the amount of the vinyl monomer is less than 5 parts by weight, a coating film is weak, so the coating film is easily damaged by external impact. Further, when the amount thereof is more than 50 parts by weight, a coating film becomes brittle, and thus the chipping resistance of the coating film becomes poor. Therefore, it is preferred that the amount of the vinyl monomer be 5˜50 parts by weight.

The polymerization initiator may be a radial reaction initiator containing peroxide and an azo compound, and may be used in an amount of 0.5˜5 parts by weight. When the amount thereof is less than 0.5 parts by weight, unreacted vinyl monomers may remain, and when the amount thereof is more than 5 parts by weight, a price increases.

When the amount of aromatic components in the acrylic modified polyester polyol resin is more than 30 parts by weight, weather resistance becomes weak. Therefore, it is preferred that the amount thereof be 30 parts or less by weight.

Descriptions of the tin-based catalyst and the solvent are the same as those of the tin-based catalyst and solvent in the above-mentioned polyester polyol resin.

Next, in the polyol resin of the present invention, the acrylic polyol resin includes 40˜70 parts by weight of a vinyl monomer, 0.5˜5 parts by weight of a polymerization initiator, and 20˜60 parts by weight of a solvent for improving workability.

The vinyl monomer used to synthesize the acrylic polyol resin may be at least one selected from among acrylic acid, methacrylic acid, acrylic acid alkyl ester, methacrylic acid alkyl ester, a hydroxy-containing vinyl monomer and a styrene monomer, and may have a glass transition temperature (Tg) of 0˜50° C. When the glass transition temperature (Tg) of the vinyl monomer is lower than 0° C., a coating film is weak, so the coating film is easily damaged by external impact. Further, when the glass transition temperature (Tg) thereof is higher than 50° C., a coating film becomes brittle, and thus the chipping resistance of the coating film becomes poor.

The polymerization initiator may be a radial reaction initiator containing peroxide and an azo compound, and may be used in an amount of 0.5˜5 parts by weight.

When the amount of aromatic components in the acrylic polyol is more than 30 parts by weight, weather resistance becomes weak. Therefore, it is preferred that the amount thereof be 30 parts or less by weight.

As described above, the synthesized polyol resin is used in an amount of 30˜70 parts by weight based on 100 parts by weight of the main material.

Next, in addition to the polyol resin, various kinds of additives of 1˜20 parts by weight of a coloring pigment, 5˜30 parts by weight of an extender pigment, 0.1˜5 parts by weight of a thickener, 0.1˜5 parts by weight of a quencher, 0.1˜1 parts by weight of a wetting and dispersing agent, 0.1˜1 parts by weight of a defoamer, 1˜5 parts by weight of an adhesion improver, 0.05˜0.5 parts by weight of a leveling agent, 0.01˜0.1 parts by weight of a reaction accelerator, 0.1˜1 parts by weight of an ultraviolet absorber and 0.1˜1 parts by weight of an ultraviolet stabilizer are added.

As the coloring pigment of the present invention, organic and inorganic pigment may each be used independently or in the form of a mixture thereof. The coloring pigment has an average particle size of 10 μm or less, and the maximum particle size thereof must be 20 μm when it is dispersed. The coloring pigment may be used in an amount of 1˜20 parts by weight based on 100 parts by weight of the main material. When the amount of the coloring pigment is less than 1 part by weight, coloring power is insufficient. Further, when the amount thereof is more than 20 parts by weight, it is difficult to treat a coating composition because the viscosity of the coating composition is increased, and the physical properties of a coating composition may be deteriorated because other additives are insufficient.

As the extender pigment of the present invention, at least one of kaolin, talc and calcite having a particle size of 10 μm or less may be used. The maximum particle size thereof must be 20 μm when it is dispersed. The addition of the extender pigment influences the control of gloss of a coating film and the improvement of mechanical properties (hardness, tensile strength and elasticity) and chipping resistance of the coating film. The extender pigment may be used in an amount of 5˜30 parts by weight based on 100 parts by weight of the main material. When the amount of the extender pigment is less than 5 parts by weight, the durability and mechanical performance of a coating film is deteriorated, thus deteriorating the chipping resistance of a coating film. Further, when the amount thereof is more than 30 parts by weight, the slippage of the surface of a coating film is deteriorated, and the surface of the coating film becomes brittle, so the chipping resistance of the coating film is deteriorated, with the result that other additives must be added in order to maintain the physical properties of the coating film, thereby causing a problem of increasing a production cost.

As the thickener of the present invention, an organic bentonite-based thickener is used to easily control rheology and prevent the precipitation of a coating composition. If necessary, this thickener can be used in the form of a gel by wetting the thickener with a solvent. The organic bentonite-based rheology adjuster (thickener) functions to maintain the storability of a coating composition because it controls the flowability of the coating composition and prevents pigment from being precipitated in the coating composition. The thickener may be used in an amount of 0.1˜5 parts by weight based on 100 parts by weight of the main material. When the amount of the thickener is less than 0.1 parts by weight, the precipitation of pigment in the coating composition becomes serious, thus deteriorating the storability of the coating composition. Further, when the amount thereof is more than 5 parts by weight, the flowability of the coating composition is deteriorated, and the viscosity thereof is increased, so it is difficult to treat the coating composition.

The quencher of the present invention functions to control the gloss of a coating composition, and may be selectively made of porous silica having a particle size of 5 μm. The quencher serves to control the gloss of the coating composition, improve the flowability thereof and increase the storage stability thereof. The quencher may be selectively used, if necessary, and may be used in an amount of 0.1˜5 parts by weight based on 100 parts by weight of the main material. When the amount of the quencher is less than 0.1 parts by weight, the quenching effect thereof is slight, thus not influencing the flowability and storage stability of the coating composition. Further, when the amount thereof is more than 5 parts by weight, the adhesion between a chrome-plated surface and the coating composition is deteriorated.

As the dispersing agent of the present invention, a wetting and dispersing agent made of a high-molecular-weight block copolymer having a pigment-friendly group may be used. The efficacy of the wetting and dispersing agent can be maximized when it is introduced into a pigment dispersing process because it easily permeates into pigment aggregates. The wetting and dispersing agent may be used in an amount of 0.1˜1 part by weight based on 100 parts by weight of the main material.

The defoamer of the present invention may be at least one selected from among a fluorine-modified polysiloxane defoamer, a silicone defoamer and a polymer defoamer such as a polyurethane defoamer. The fluorine-modified polysiloxane defoamer exhibits strong defoaming ability because it has low surface tension. The silicone defoamer is characterized in that its defoaming ability can be controlled by the molecular weight and chain length thereof because it selectively uses incompatible and insoluble polysiloxanes. The polymer defoamer is characterized in that its compatibility and incompatibility can be suitably adjusted by adjusting the polarity and molecular weight thereof. Preferably, as the polymer defoamer, a polyurethane defoamer may be used. The defoamer may be used in an amount of 0.1˜1 part by weight based on 100 parts by weight of the main material. When the amount of the defoamer is less than 0.1 parts by weight, the defoamer does not influence a defoaming action, and when the amount thereof is more than 1 part by weight, a cratering phenomenon may occur. It is preferred that the defoamer be introduced during a dispersing process. If the defoamer is introduced during a finishing process, a cratering phenomenon may occur.

As the adhesion improver of the present invention, a phosphate-based adhesion improver may be used. The phosphate-based adhesion improver has a number average molecular weight of 500˜1000, and includes an oxide group and a hydroxy oxide group, thus increasing the adhesion between a coating composition and a chrome-plated surface. The adhesion improver may be used in an amount of 1˜5 parts by weight based on 100 parts by weight of the main material. When the amount of the adhesion improver is less than 1 part by weight, the adhesion between a coating composition and a chrome-plated surface is slightly increased, and when the amount thereof is more than 5 parts by weight, the water resistance of a coating composition becomes poor, blisters may occur.

The leveling agent of the present invention may be at least one selected from among a polyether-modified polydimethylsiloxane solution, a polyester-modified polydimethylsiloxane solution, which are polysiloxane-based additives, and an acrylate copolymer solution, which is a polyacrylate additive. Among these leveling agents, the polysiloxane-based additive serves to prevent the wettability and cratering phenomenon of a liquid coating composition by greatly decreasing the surface tension of the liquid coating composition, to improve the surface slippage of a dry coating film and to improve the scratch resistance of the dry coating film. The polyacrylate additive serves to improve the surface flowability of a coating composition because it can uniformalize the difference in surface tension. The leveling agent may be used in an amount of 0.05˜0.5 parts by weight based on 100 parts by weight of the main material. When the amount of the leveling agent is present in this range, the surface tension of a coating composition decreases, thus preventing a cratering phenomenon. However, when the amount thereof is less than 0.05 parts by weight, the function of the leveling agent as an additive cannot be easily exhibited, and when the amount thereof is more than 0.5 parts by weight, bubbles are stabilized, and thus the surface of a coating composition may be foamed.

The reaction accelerator of the present invention is used to react an OH of the main material with an NCO group of the curing agent at a ratio of 1:0.8˜1.2 using a urethane bond and to accelerate the reaction. The reaction accelerator serves to accelerate the reaction of an OH of polyol as the main material with an NCO group of a resin for the curing agent. The reaction accelerator may be used in an amount of 0.01˜0.1 parts by weight based on 100 parts by weight of the main material. As the reaction accelerator, DBTDL (dibutyl thin dilaurate) may be used.

As the ultraviolet absorber of the present invention, at least one of a benzotriazole type ultraviolet absorber, a benzophenone type ultraviolet absorber, an oxalanilide type ultraviolet absorber and a triazine type ultraviolet absorber may be used. The ultraviolet absorber may be used in an amount of 0.1˜1.0 part by weight based on 100 parts by weight of the main material. When the amount of the ultraviolet absorber is less than 0.1 parts by weight, a coating film is degraded, so the gloss loss, cracking, yellowing, swelling and discoloration of the coating film are caused. Further, when the amount thereof is more than 1.0 part by weight, economical efficiency is lowered.

As the ultraviolet stabilizer of the present invention, HALS (hindered amine light stabilizer) is used in an amount of 0.1˜1 part by weight. The ultraviolet stabilizer serves to treat radicals occurring due to the fact that ultraviolet (UV) is not completely blocked 100% by the ultraviolet absorber. When the amount of the ultraviolet stabilizer is less than 0.1 parts by weight, the effects of preventing the gloss loss, cracking, yellowing, swelling and discoloration of a coating film are lowered. Further, when the amount thereof is more than 1.0 part by weight, economical efficiency is lowered.

The solvent for the main material according to the present invention includes at least one of aliphatic, cycloaliphatic and aromatic solvents of 2˜10 carbon atoms in an amount of 2˜40 parts by weight.

Next, a curing agent will be described.

The curing agent of the present invention is a mixture of a resin for a curing agent and a solvent for a curing agent. The curing agent is used in an amount of 10˜30 parts by weight based on 100 parts by weight of the main material. The curing agent includes 5˜20 parts by weight of a resin for a curing agent and 5˜15 parts by weight of a solvent for a curing agent.

As the resin of a curing agent, a non-yellowing type isocyanate trimer may be used. When a biuret type isocyanate trimer is used as the resin for a curing agent, the hardness and chipping resistance of a urethane-coated film can be maintained. Further, when an isocyanurate type isocyanate trimer is used as the resin of a curing agent, the hardness of a coating film can be increased, and the thermal stability and chemical stability thereof can be improved compared to when the biuret type isocyanate trimer is used, but the strength of the coating film is increased, so the toughness thereof is deteriorated, thereby deteriorating the chipping resistance thereof. At least one of these isocyanate trimers may be used as the resin for a curing agent. The resin for a curing agent may be used in an amount of 5˜20 parts by weight based on 100 parts by weight of the main material such that the resin for a curing agent reacts with the resin for the main material at a ratio of 1:0.8˜1.2 equivalents. When the resin for a curing agent is used in an amount of less than 0.8 equivalents, the hardness of a coating film is deteriorated because the crosslink density thereof is lowered, and the water resistance of the coating film is lowered because of residual OH groups of a polyol resin. Further, when the resin for a curing agent is used in an amount of more than 1.2 equivalents, the hardness of a coating film is increased because the crosslink density thereof is increased, but the flexibility and chipping resistance thereof are deteriorated.

In the present invention, the solvent of a curing agent is selected from among aliphatic, cycloaliphatic and aromatic solvents of 2˜10 carbon atoms, and is included in an amount of 5˜15 parts by weight based on 100 parts by weight of the main material.

Hereinafter, the present invention will be described in more detail with reference to the following Examples. However, these Examples are set forth to illustrate the present invention, and the scope of the present invention is not limited thereto.

### Comparative Example 1

In Comparative Example 1, a commercially available two-time applicable coating composition including a primer coating material and a finish coating material was used. Here, the primer coating material is a light gray two-component coating material which includes a main material containing a polyester resin and a curing agent containing an isocyanurate trimer as an isocyanate trimer and in which a mixing ratio (weight ratio) of the main material to the curing agent is 20:1. Further, the finish coating material is a black two-component coating material which includes a main material containing an acrylic polyol resin and a curing agent containing an isocyanurate trimer as an isocyanate trimer and in which a mixing ratio (weight ratio) of the main material to the curing agent is 4:1.

### Comparative Example 2

In Comparative Example 2, a two-time applicable coating composition, manufactured by Juyoung Corporation, including a primer coating material and a finish coating material was used. Here, the primer coating material is a black two-component coating material which includes a main material containing a polyester resin and a curing agent containing an isocyanurate trimer as an isocyanate trimer and in which a mixing ratio (weight ratio) of the main material to the curing agent is 20:1. Further, the finish coating material is a black two-component coating material which includes a main material containing a polyester resin and a curing agent containing an isocyanurate trimer as an isocyanate trimer and in which a mixing ratio (weight ratio) of the main material to the curing agent is 5:1.

### Example 1

In Example 1, a one-time applicable coating composition including a main material and a curing agent, in which a primer coating material is combined with a finish coating material, was used. A polyester polyol resin of the main material was prepared as follows. A carboxylic acid or a derivative thereof and a glycol having hydroxy groups (OH) polycondensable therewith were introduced into a nitrogen-suppliable four-neck flask provided with a condenser, a thermometer and a glycol recovery unit, stirred, and heated to 150° C. After 1 hour, the reaction product was stepwisely heated to 220° C. at a heating rate of 10° C./hr, and then the viscosity and acid value thereof were measured every hour at 220° C. Then, the reaction product was cooled at a suitable viscosity and acid value, and then diluted with an organic solvent to prepare a polyester polyol resin. The prepared polyester polyol resin had a viscosity of Z₂ (Gardner tube), a solid content of 60%, an OH content of 4.0% and a number average molecular weight of 6,950.

In order to prepare a main material, 400 g of a polyol resin (solid content 60%, OH %=4.0), 30 g of a black pigment, 250 g of an extender pigment, 5 g of a quencher, 5 g of a dispersant, 5 g of a defoamer and 20 g of organic bentonite were mixed, and then the mixture was dispersed to a maximum particle size of 20 μm by a sand mill. Subsequently, 1 g of a reaction accelerator, 5 g of an ultraviolet stabilizer, 5 g of an ultraviolet absorber, 40 g of an adhesion improver and 5 g of a leveling agent were added to the dispersed mixture and dissolved in a solvent to prepare a main material. The prepared main material had a viscosity of 73 KU (Krebs Stomer viscometer), a solid content of 59% and a specific gravity of about 1.1.

Subsequently, 200 g of a curing agent containing 144 g of an isocyanate trimer and 56 g of a solvent was mixed with 1 kg of the main material such that the mixing ratio (weight ratio) of the main material to the curing agent is 5:1, thus finally obtaining a two-component coating composition.

### Example 2

In Example 2, a one-time applicable coating composition including a main material and a curing agent, in which a primer coating material is combined with a finish coating material, was used. An acrylic modified polyester polyol resin of the main material was prepared as follows. A carboxylic acid or a derivative thereof and a glycol having hydroxy groups (OH) polycondensable therewith were introduced into a nitrogen-suppliable four-neck flask provided with a condenser, a thermometer and a glycol recovery unit, stirred, and heated to 150° C. After 1 hour, the reaction product was stepwisely heated to 220° C. at a heating rate of 10° C./hr, and then the viscosity and acid value thereof were measured every hour at 220° C. Then, the reaction product was cooled at a suitable viscosity and acid value, and then diluted with an organic solvent. The diluted reaction product was reacted with a vinyl monomer and a reaction initiator at 120° C. for 3 hours and then maintained for 3 hours to prepare an acrylic modified polyester polyol resin. The prepared acrylic modified polyester polyol resin had a viscosity of Z₃ (Gardner tube), a solid content of 60%, an OH content of 4.0% and a number average molecular weight of 7,490.

Subsequently, the additives of Example 1 were added to 400 g of the prepared acrylic modified polyester polyol resin to prepare a main material (1 kg). The prepared main material had a viscosity of 78 KU, a solid content of 59% and a specific gravity of about 1.1.

Subsequently, a curing agent was added to the prepared main material in the same manner as in Example 1, thus finally obtaining a two-component coating composition.

### Example 3

In Example 3, a one-time applicable coating composition including a main material and a curing agent, in which a primer coating material is combined with a finish coating material, was used. An acrylic polyol resin of the main material was prepared as follows. A suitable amount of an organic solvent was introduced into a temperature-controllable four-neck flask provided with a condenser and a thermometer, and then heated to 120° C. Then, the organic solvent was reacted with a vinyl monomer and a reaction initiator at 120° C. for 3 hours and then maintained for 3 hours to prepare an acrylic polyol resin. The prepared acrylic polyol resin had a viscosity of Z₁ (Gardner tube), a solid content of 60%, an OH content of 4.0% and a number average molecular weight of 6,510.

Subsequently, the additives of Example 1 were added to 400 g of the prepared acrylic polyol resin to prepare a main material (1 kg). The prepared main material had a viscosity of 72 KU, a solid content of 59% and a specific gravity of about 1.1.

Subsequently, a curing agent was added to the prepared main material in the same manner as in Example 1, thus finally obtaining a two-component coating composition.

### Test Example 1

### Evaluation of Physical Properties of an Automobile Exterior Part (1)

In Comparative Examples 1 and 2, as a test piece for coating, a trivalent chrome-plated test piece having a size of 14 cm×7.5 cm, which had been fabricated in the same manner as in a process of producing a radiator grill, was used. A primer coating material was applied onto the test piece to a thickness of 15 μm (thickness of dry coating film), and then dried at room temperature for 5 minutes. Then, a finish coating material was applied onto the test piece coated with the primer coating material to a thickness of 20 μm (thickness of dry coating film), left at room temperature for 10 minutes, dried at 70° C. for 1 hour, then left at room temperature for at least 72 hours, and then tests were carried out according to the following test items.

In Examples 1 to 3, a coating composition, in which a primer coating material is combined with a finish coating material, was applied onto the test piece to a thickness of 30 μm (thickness of dry coating film), left at room temperature for 10 minutes, dried at 70° C. for 1 hour, then left at room temperature for at least 72 hours, and then tests were carried out according to the following test items.
Adhesiveness standard: ISO 2409 (Cross cut tape test=M-2.5 or more)−Cross cut tape test standard

M-1: a surface damage of a coating film is not recognized

M-2: a coating film is stripped from the test piece by 5% or less

M-3: a coating film is stripped from the test piece by 5˜15%

M-4: a coating film is stripped from the test piece by 15˜35%

M-5: a coating film is stripped from the test piece by 35˜65%

M-6: a coating film is completely stripped from the test piece.
Water resistance test: Moisture is removed from a coating film at a test temperature of 40±2° C. for 240 hours using an air blower, and then the state of the surface of the coating film is observed, and immediately an adhesion test is carried out.
Acid resistance test: 0.2 mL of a 0.1 N hydrochloric acid is dripped onto a coating film and then left at room temperature for 24 hours, and then moisture is removed from the coating film using an air blower and then dried for 1 hour, and then the state of the surface of the coating film is observed.
Alkali resistance test: 0.2 mL of a 0.1 N sodium hydroxide is dripped onto a coating film and then left at room temperature for 24 hours, and then moisture is removed from the coating film using an air blower and then dried for 1 hour, and then the state of the surface of the coating film is observed.
Salt water resistance test: Salt water is sprayed onto a coating film under the conditions of a temperature of 35±2° C., a relative humidity (RH) of 95%, a spray rate of 0.5˜3 mL/hr, a salt water concentration of 5±1 w/v % and a salt water acidity (pH) of 6.5˜7.2 according to ISO 7253 or JIS K 5600-7-1, and then moisture is removed from the coating film using an air blower and then dried for 1 hour, and then the state of the surface of the coating film is observed, and an adhesion test is carried out immediately.
Heat resistance test: A coating film is heated to 80±2° C. for 300 hours, and then moisture is removed from the coating film using an air blower and then dried for 1 hour, and then the state of the surface of the coating film is observed, and an adhesion test is carried out immediately.
Thermal cycle resistance test: A thermal cycle of 80±2° C.×3 hours, room temperature×1 hour, −40±2° C.×3 hours, room temperature×1 hour, 50±2° C., 95±2% RH×7 hours and room temperature×1 hour is repeated five times. The test piece coated with a coating film is left at room temperature for 1 hour, and then the state of the surface of the coating film is observed, and an adhesion test is carried out immediately.
Chipping resistance test: Chipping resistance of the test piece coated with a coating film is tested by a gravelo meter (SAE J 400 standard) according to the following conditions. Then, dust is removed from the surface of the test piece using an air blower, and then the appearance thereof is observed by the naked eye.

Shooting Distance: 100 mm, Shooting Angle: 45°, Shooting Pressure: 4 kgf, Test Temperature: room temperature (23° C.). Gravel stone: 50 g (JIS Crused gravel No 7 stone, 2.5˜5 mm 350˜400, reusable eight times).

Table 1 below compares the physical properties of two-time applicable coating compositions (Comparative Examples 1 and 2) with those of one-time applicable coating compositions (Examples 1, 2 and 3) according to the standards of A motor company.

TABLE 1

| | | Comp. | Comp. | | | |
|---|---|---|---|---|---|---|
| | | Ex. 1 | Ex. 2 | Ex. 1 | | |
| | | (applied | (applied | (applied | Ex. 2 | Ex. 3 |
| Physical | | two | two | one | (applied | (applied |
| properties | Requirements | times) | times) | time) | one time) | one time) |
| Chipping | 1 mm or less | 0.527 mm | 0.623 mm | 0.65 mm | 0.68 mm | 0.69 mm |
| resistance | | | (average | (average | (average | (average |
| | | | 5 times) | 5 times) | 5 times) | 5 times) |
| Water | appearance | normal | normal | normal | normal | normal |
| resistance | adhesiveness | M-2.0 | M- | M- | M-2.0 | M-2.0 |
| | (M-2.5 or | | 1.5~2.0 | 2.0~2.5 | | |
| | less) | | | | | |
| Moisture | appearance | normal | normal | normal | normal | normal |
| resistance | adhesiveness | M-1.5 | M- | M- | M-2.0 | M-1.5 |
| (R.H95% * 336 h) | (M-2.5 or | | 1.0~1.5 | 1.5~2.0 | | |
| | less) | | | | | |
| Alkali | observation | normal | normal | normal | normal | normal |
| resistance | with naked | | | | | |
| | eye | | | | | |
| Acid resistance | observation | normal | normal | normal | normal | normal |
| | with naked | | | | | |
| | eye | | | | | |
| Heat resistance | observation | normal | normal | normal | normal | normal |
| | with naked | | | | | |
| | eye | | | | | |
| | adhesiveness | M-1.5 | M- | M- | M-2.0 | M-2.0 |
| | (M-2.5 or | | 1.5~2.0 | 2.0~2.5 | | |
| | less) | | | | | |
| Salt water | observation | normal | normal | normal | normal | normal |
| spray | with naked | | | | | |
| | eye | | | | | |
| Thermal cycle | observation | normal | normal | normal | normal | normal |
| resistance | with naked | | | | | |
| | eye | | | | | |
| | adhesiveness | M-2.0 | M- | M- | M-2.0 | M-2.0 |
| | (M-2.5 or | | 1.5~2.0 | 2.0~2.5 | | |
| | less) | | | | | |

From the results shown in Table 1 above, it can be seen that the coating compositions of Comparative Examples 1 and 2 and the coating compositions of Examples 1, 2 and 3 exhibit excellent chipping resistances, and that the chipping resistances of the coating compositions of Comparative Examples 1 and 2 are similar to those of the coating compositions of Examples 1, 2 and 3. Further, it can be seen that the water resistance, moisture resistance, alkali resistance, acid resistance, heat resistance, salt water resistance and thermal cycle resistance of the coating compositions of Examples 1, 2 and 3 are the same as each other. Consequently, it can be ascertained that all of the coating compositions of Comparative Examples 1 and 2 can be replaced by the coating compositions of Examples 1, 2 and 3.

### Test Example 2

### Evaluation of Physical Properties of an Automobile Exterior Part (2)

The physical properties of a coating composition of Comparative Example 2 and coating compositions of Examples 1, 2 and 3 were evaluated.

In Comparative Example 2, as a test piece for coating, a trivalent chrome-plated test piece having a size of 14 cm×7.5 cm, which had been fabricated in the same manner as in a process of producing a radiator grill, was used. A primer coating material was applied onto the test piece to a thickness of 10˜15 μm, and then dried at room temperature for 5 minutes. Then, a finish coating material was applied onto the test piece coated with the primer coating material to a thickness of 20˜25 μm, left at room temperature for 10 minutes, dried at 70° C. for 1 hour, then left at room temperature for at least 72 hours, and then a test was carried out according to the following test items.

In Examples 1, 2 and 3, a coating composition, in which a primer coating material is combined with a finish coating material, was applied onto the test piece to a thickness of 30 μm, left at room temperature for 10 minutes, dried at 70° C. for 1 hour, then left at room temperature for at least 72 hours, and then tests were carried out according to the following test items.
Adhesion test: Cross cut Tape Adhesion test
Solvent resistane test: Iso-Propyl Alcohol, carried out 10 times
Moisture resistance test: 96 hours×38° C.+100% RH, appearance is abnormal, Cross cut Tape Adhesion test 240 hours×38° C.+100% RH, appearance is abnormal, Cross cut Tape Adhesion test
Chipping resistance test: −18±2° C.×3, a gravelo meter is used
Gasoline resistance test: a test piece is immersed in a beaker filled with gasoline for 20 seconds (10 cycles)
Chemical resistance test: a test piece is immersed in a chemical such as a car cleaner or the like under the conditions of 21˜25° C.+30˜50% RH.
Moisture cold test: 15 cycles (room temperature 1 hour+100% RH 20 hours+−30° C.×1 hour)+24 hours 100% RH+Tape Adhesion test
Oven age test: 83° C.×16 hours+−18° C.±2° C., chipping resistance test

Table 1 below compares the physical properties of a two-time applicable coating composition (Comparative Example 2) with those of one-time applicable coating compositions (Examples 1, 2 and 3) according to the standards of B motor company.

TABLE 2

| | | Comp. | | | |
|---|---|---|---|---|---|
| Test items | Requirements | Ex. 2 | Ex. 1 | Ex. 2 | Ex. 3 |
| Adhesiveness | grade 1 or less | grade 0 | grade 0 | grade 0 | grade 0 |
| Solvent | grade 1 or less | grade 1 | grade 1 | grade 1 | grade 1 |
| resistance | | | | | |
| Moisture | appearance was | grade 0 | grade 0 | grade 0 | grade 0 |
| resistance | changed | | | | |
| (96 hours) | grade 1 or less | | | | |
| Moisture | appearance was | grade 0 | grade 0 | grade 0 | grade 0 |
| resistance | changed | | | | |
| (240 hours) | grade 1 or less | | | | |
| Chipping | grade 7 or more | grade 7 | grade 7 | grade 7 | grade 7 |
| resistance | | | | | |
| Gasoline | grade 2 or less | grade 1 | grade 1 | grade 1 | grade 1 |
| resistance | | | | | |
| Chemical | grade 4 or more | grade 4 | grade 4 | grade 4 | grade 4 |
| resistance | | | | | |
| Moisture | No change | grade 0 | grade 0 | grade 0 | grade 0 |
| cold | grade 1 or less | | | | |
| Oven age | grade 7 or more | grade 7 | grade 7 | grade 7 | grade 7 |

From the results shown in Table 1 above, it can be seen that the adhesiveness, solvent resistance, moisture resistance, gasoline resistance, chemical resistance, moisture cold and oven age of the one-time applicable coating compositions of Examples 1, 2 and 3 are the same as those of the two-time applicable coating composition of Comparative Example 2, respectively. Consequently, it can be ascertained that the two-time applicable coating composition of Comparative Example 2 can be replaced by the one-time applicable coating compositions of Examples 1, 2 and 3.

As described above, the two-component coating composition for a chrome-plated radiator grill according to the present invention can improve field coating productivity and workability because it can be applied to the chrome-plated surface of a radiator grill one time although a conventional coating composition including a primer coating material and a finish coating material are sequentially applied two times. Further, the two-component coating composition can greatly reduce a production cost because it can be applied to the chrome-plated surface of a radiator grill one time to form a dry coating film having a thickness of 25˜30 μm, thus reducing the use of the coating composition corresponding to the coating film having a thickness of about 5 μm and reducing one-time coating work, although a conventional coating composition including a primer coating material and a finish coating material sequentially applied two times to such a degree that the primer coating material is formed into a dry film having a thickness of 15 μm and then the finish coating material is formed into a dry film a thickness of 20 μm.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention. Accordingly, any and all modifications, variations or equivalent arrangements should be considered to be within the scope of the invention, and the detailed scope of the invention will be disclosed by the accompanying claims.

What is claimed is:

1. A two-component coating composition, which is applied to a chrome-plated surface one time to impart adhesiveness and chipping resistance, comprising:
100 parts by weight of a main material which includes 30˜70 parts by weight of at least one polyol resin selected from among a polyester polyol resin, an acrylic modified polyester polyol resin and an acrylic polyol resin, the polyol resin containing 40˜70% of solid and 0.5˜5% of a hydroxy group and having a number average molecular weight of 1,000˜20,000, 1˜20 parts by weight of a coloring pigment, 5˜30 parts by weight of an extender pigment, 0.1˜5 parts by weight of a thickener, 0.1˜1 parts by weight of a wetting and dispersing agent, 0.1˜1 parts by weight of a defoamer, 1˜5 parts by weight of an adhesion improver, 0.05˜0.5 parts by weight of a leveling agent, 0.01˜0.1 parts by weight of a reaction accelerator, 0.1˜1 parts by weight of an ultraviolet absorber, 0.1˜1 parts by weight of an ultraviolet stabilizer and 20˜40 parts by weight of a mixed solvent; and
10˜30 parts by weight of a curing agent which includes 5˜20 parts by weight of a resin for a curing agent and 5˜15 parts by weight of a solvent for a curing agent.

2. The two-component coating composition of claim 1, wherein the polyester polyol resin comprises, based on 100 parts by weight of the polyol resin:
10˜60 parts by weight of carboxylic acid and a derivative thereof;
10˜50 parts by weight of a glycol of 2˜10 carbon atoms having 2˜4 hydroxy groups;
0.001˜1 parts by weight of a tin-based catalyst for controlling a reaction rate; and
20˜60 parts by weight of a solvent for improving workability.

3. The two-component coating composition of claim 2, wherein 10˜60 parts by weight of the carboxylic acid and derivative thereof includes 10˜30 parts by weight of aromatic carboxylic acid and a derivative thereof,
10˜50 parts by weight of the glycol of 2˜10 carbon atoms having 2˜4 hydroxy groups includes 10˜30 parts by weight of a glycol of 2˜10 carbon atoms having 3˜4 hydroxy groups,
the tin-based catalyst is DTBO (dibutyl tin oxide) or HMBTO (hydrated monobutyl tin oxide), and
the solvent is an aliphatic, cycloaliphatic or aromatic solvent of 2˜10 carbon atoms.

4. The two-component coating composition of claim 1, wherein the acrylic modified polyester polyol resin comprises, based on 100 parts by weight of the polyol resin:
3˜30 parts by weight of carboxylic acid and a derivative thereof;
2˜30 parts by weight of a glycol of 2˜10 carbon atoms;
5˜50 parts by weight of a vinyl monomer;
0.5˜5 parts by weight of a polymerization initiator;
0.001˜1 parts by weight of a tin-based catalyst for controlling a reaction rate; and
20˜60 parts by weight of a solvent for improving workability.

5. The two-component coating composition of claim 4, wherein 3˜30 parts by weight of the carboxylic acid and derivative thereof includes 1˜10 parts by weight of aromatic carboxylic acid having a double bond and a derivative thereof,
2˜30 parts by weight of the glycol of 2˜10 carbon atoms includes 20 parts or less by weight of a glycol having 3˜4 hydroxy groups,
the vinyl monomer is at least one selected from among acrylic acid, methacrylic acid, acrylic acid alkyl ester, methacrylic acid alkyl ester, a hydroxy-containing vinyl monomer and a styrene monomer,
the polymerization initiator is a radial reaction initiator containing peroxide and an azo compound,
the tin-based catalyst is DTBO (dibutyl tin oxide) or HMBTO (hydrated monobutyl tin oxide), and
the solvent is an aliphatic, cycloaliphatic or aromatic solvent of 2˜10 carbon atoms.

6. The two-component coating composition of claim 1, wherein the acrylic polyol resin comprises, based on 100 parts by weight of the polyol resin:
40˜70 parts by weight of a vinyl monomer;
0.5˜5 parts by weight of a polymerization initiator; and
20˜60 parts by weight of a solvent for improving workability.

7. The two-component coating composition of claim 6, wherein the vinyl monomer is at least one selected from among acrylic acid, methacrylic acid, acrylic acid alkyl ester, methacrylic acid alkyl ester, a hydroxy-containing vinyl monomer and a styrene monomer,
the polymerization initiator is a radial reaction initiator containing peroxide and an azo compound, and
the solvent is an aliphatic, cycloaliphatic or aromatic solvent of 2˜10 carbon atoms.

8. The two-component coating composition of claim 1, wherein the coloring pigment is an organic pigment, an inorganic pigment or a mixture thereof, and has an average particle size of 10 μm or less.

9. The two-component coating composition of claim 1, wherein the extender pigment is at least one selected from among kaolin, talc and calcite, and has an average particle size of 10 μm or less.

10. The two-component coating composition of claim 1, further comprising 0.1˜5 parts by weight of a quencher, wherein the quencher is porous silica.

11. The two-component coating composition of claim 1, wherein the wetting and dispersing agent is a high-molecular-weight block copolymer having a pigment-friendly group.

12. The two-component coating composition of claim 1, wherein the defoamer is at least one selected from among fluorine-modified polysiloxane, silicone and polyurethane.

13. The two-component coating composition of claim 1, wherein the adhesion improver is a phosphate-based adhesion improver to improve adhesiveness between a chrome-plated surface and a black coating material.

14. The two-component coating composition of claim 1, wherein the leveling agent is at least one selected from among a polyether-modified polydimethylsiloxane solution, a polyester-modified polydimethylsiloxane solution and an acrylate copolymer solution.

15. The two-component coating composition of claim 1, wherein the resin for a curing agent is an isocyanate trimer.
